(19) United States
(12) Patent Application Publication
(10) Pub. No.: US 2012/0270420 A1
(43) Pub. Date: Oct. 25, 2012

(54) Board Mounted Connector

(76) Inventor: Doron Lapidot, Tokyo (JP)

(21) Appl. No.: 13/536,162

(22) Filed: Jun. 28, 2012

Related U.S. Application Data
(63) Continuation of application No. PCT/JP2010/007379, filed on Dec. 20, 2010.

(30) Foreign Application Priority Data
Dec. 28, 2009 (JP) 2009-298484

(51) Int. Cl. H01R 12/71

(52) U.S. Cl. 439/65

(57) ABSTRACT

A board mounted connector is provided in which a skew occurrence can be prevented between adjacent sets of contacts. The board mounted connector having a housing and a plurality of contacts provided in the housing that are connected to a printed circuit board. Each of the plurality of contacts include a contact portion, a securing portion, and a board connecting portion that connect to the printed circuit board. The plurality of contacts include a first signal contact and a second signal contact positioned next to the first signal contact such that the first signal contact and the second signal contact form a first set of signal contacts positioned along the printed circuit board. The first signal contact is arranged on an inner side of the printed circuit board while the second signal contact is arranged on an outer side of the printed circuit board.

### CROSS-REFERENCE TO RELATED APPLICATION

This application is a continuation of PCT International Application No. PCT/JP2010/007379 filed Dec. 20, 2010, which claims priority under 35 U.S.C. §119 to Japanese Patent Application No. 2009-2989484, filed Dec. 28, 2009.

### FIELD OF THE INVENTION

The invention relates to a connector and, more particularly, to a board mounted connector having multiple contacts for connection with a printed circuit board.

### BACKGROUND

With advancements in information processing and communications equipment and increased capacity of data for moving images, high-speed signals for use in equipment is in high demand. In addition, connectors for transmitting high-speed differential signals have been developed to achieve the increase in signal speed.

Furthermore, in brief, the signal transmission methods include an unbalanced transmission system (single-ended signaling system) and a balanced transmission system (differential signaling system).

The unbalanced transmission system (single-ended signaling system) distinguishes between High and Low by the potential difference between a ground line and a (single) signal line, and is well known and commonly used.

In contrast thereto, two signal lines (+, −) are used in the balanced transmission system (differential signaling system), so that High and Low are distinguished by the potential difference between the two signal lines. The two signals in the differential signaling are same in the voltage magnitude and different in phase by 180 degrees. In the differential signaling system, since noises made in the two signal lines are cancelled at an input stage of the receiver, it is possible to transmit signals with certainty, as compared to the single-ended signaling system.

Connectors shown in FIG. 7A, FIG. 7B, and FIG. 8 are known (see JP 2002-334748 A), for use in transmitting high-speed differential signals in the conventional balanced transmission system (differential signaling system).

The connector 100 for transmitting the high-speed differential signals (hereinafter, simply referred to as connector) shown in FIG. 7A, FIG. 7B, and FIG. 8 is provided with a housing 110, multiple contacts 120, and a shell 130.

The multiple contacts 120 include a plurality of signal contacts S (hereinafter, simply referred to as “S”) arranged along upper and lower rows of the housing 110, a plurality of ground contacts G (hereinafter, simply referred to as “G”), and a plurality of contacts D for low-speed transmission (hereinafter, simply referred to as “D”). Each contact 120 is provided with a contact portion 121 for contact with a mating contact (not shown), and a board connecting portion 122 for connection with a printed circuit board PCB. Each contact 120 is secured to the housing 110 at a secured portion positioned horizontal with respect to the housing 110, as shown in FIG. 8. The contact portion 121 extends substantially frontward from the secured portion. The board connecting portion 122 extends from the secured portion backward, then bends downward at right angle, and extends from the housing 110 to penetrate through the printed circuit board PCB. The upper-row contact 120 is located on a back side of the lower-row contact 120 in the board connecting portion 122, as shown in FIG. 8. On the other hand, the lower-row contact 120 is located on a front side of the upper-row contact 120 in the board connecting portion 122.

In the embodiment shown in FIG. 7B, the multiple contacts 120 are located at a mating portion in the order of S, S, G, S, S, G, D, D, and D from a right side along the upper TOW.

In addition, the multiple contacts 120 are located at the mating portion in the order of G, S, S, G, S, S, D, and D from the right side along the lower row.

The rightmost S and its adjacent S in the upper row and the rightmost G in the lower row at the mating portion constitute a first set P1 of an isosceles triangle. Then, G in the lower row is located at a top vertex of the isosceles triangle, and the S and adjacent S in the upper row are located at two base vertexes in the base of the isosceles triangle. Additionally, the G in the lower row is located on the front side to be the top vertex of the isosceles triangle, in the board connecting portion 122 of the contact 120, as shown in FIG. 7A. Furthermore, the S and the adjacent S in the upper row are located on the back side to be the two base vertexes in the base of the isosceles triangle. One of adjacent signal contacts the S and S constitute the two base vertexes in the base is a + signal contact, and the other thereof is a − signal contact.

In addition, the S and S adjacent to the G of the first set P1 in the lower row at the mating portion and G adjacent to the S of the first set P1 in the upper row constitutes a second set P2. Then, the G in the upper row is located at a top vertex of the isosceles triangle, and the S and S in the lower row are located at two base vertexes in the base of the isosceles triangle. Additionally, the G in the upper row is located on the back side to be the top vertex of the isosceles triangle, in the board connecting portion 122 of the contact 120, as shown in FIG. 7A. Furthermore, the adjacent signal contacts S and S in the lower row are located on the front side to be the two base vertexes of the isosceles triangle. One of the S and S constituting the two base vertexes in the base is a + signal contact, and the other thereof is a − signal contact.

In addition, in the connector 100, there is provided a third set P3 having the same contact arrangement with that of the set P1, and a fourth set P4 having the same contact arrangement with that of the second set P2.

Furthermore, the shell 130 is configured to cover the housing 110, and a mating plug connector (not illustrated) is adapted to fit there into. The shell 130 includes springs 131 to engage with engagement holes (not shown) provided in the mating plug connector.

In the connector 100 shown in FIG. 7A, FIG. 7B, and FIG. 8, the G (ground contact) is located on the top vertex of the isosceles triangle, and the S (+ signal contact) and the S (− signal contact) are located on the base vertexes in the base of the isosceles triangle. This makes the distance between the G (ground contact) and the S (+ signal contact) equal to the distance between the G (ground contact) and the S (− signal contact). Accordingly, the impedance matching between the G (ground contact) and the S (+ signal contact), and the G (ground contact) and the S (− signal contact) is attained equally, so that the high-speed transmission properties can be maintained in the transmission of the high-speed differential signals.

Moreover, the S (+ signal contact) and the S (− signal contact) are arranged to interpose the G (ground contact), making impedance matching easy.

However, it should be noted that the conventional connector 100 has the following problem.

That is, there is a problem that skew or skewness (displacement between signals) occurs between, for example, the S, the S, and the G constituting the first set P1 and the S, the S, and the G constituting its adjacent second set P2, because the S and S in the first set P1 and the S and S in the second set P2 have different electrical lengths. This problem will be described as follows. The S, the S, and the G constituting the first set P1 includes two rightmost signal contacts S and S in the upper row and one rightmost the G in the lower row in FIG. 7B. As to the S, the S, and the G constituting the first set P1, the G in the lower row is located on the front side to be the top vertex of the isosceles triangle in the board connecting portion 122 of the contact 120, as shown in FIG. 7A. In addition, adjacent signal contacts S and S in the upper row are located on the back side, and are the two base vertexes in the base of the isosceles triangle. Furthermore, in the S, the S, and the G constituting the first set P1, the S and S are located in the upper row.

As shown in FIG. 8, when the electrical length starts from the contact portion 121 and extends to a goal of a predefined point in a circuit on the Printed Circuit Board (PCB), the electrical length can be represented as follows

When L is the electrical length of each of the S and S in the first set P1,

L=L1+L2+L3 (1),

where L1 denotes a length from the contact portion 121 (start) of the contact 120 in the upper row to a point bending at right angle, L2 denotes a length from the point bending at right angle of the contact 120 to a point reaching the board connecting portion 122 on the printed circuit board PCB, and L3 denotes a length from the point reaching the board connecting portion 122 of the contact 120 to the goal.

On the other hand, the S, the S, and the G constituting the second set P2 adjacent to the first set P1 includes two the S and S on the rightmost side in the lower row and one the G on the rightmost side in the upper row, in FIG. 7B. In the S, the S, and the G constituting the second set P2, the G in the upper row is located on the back side to be the top vertex of the isosceles triangle in the board connecting portion 122 of the contact 120, as shown in FIG. 7A. In addition, the adjacent signal contacts S and S adjacent to each other in the lower row are located on the front side to be the two base vertexes in the base of the isosceles triangle. Furthermore, in the S, the S, and the G constituting the second set P2, the S and S are located in the lower row. As shown in FIG. 8, when the electrical length starts from the contact portion 121 and extends to the goal of a predefined point in a circuit on the Printed Circuit Board (PCB), the electrical length can be represented as follows When L′ is the electrical length of each of the S and S in the second set P2,

L′=L11+L12+L13 (2),

where L11 denotes a length from the contact portion 121 (start) of the contact 120 in the lower row to a point bending at right angle, L12 denotes a length from the point bending at right angle of the contact 120 to a point reaching the board connecting portion 122 of the printed circuit board PCB, and L13 denotes a length from the point reaching the board connecting portion 122 of the contact to the goal.

The electrical length L in the expression (1) can be represented as follows by using L11, L12, and L13.

When the electrical length L of each of the S and S in the first set P1,

L=(L11+dw)+(L12+dh)+(L13−dw)=L11+L12+L13+dh (3),

where dw denotes a length in a horizontal direction from the board connecting portion 122 of the contact 120 in the lower row to the board connecting portion 122 of the contact 120 in the upper row, and dh denotes a length in a vertical direction from the bending portion of the contact 120 in the upper row to the bending portion of the contact 120 in the lower row.

Then, when the expressions (2) and (3) are compared, it is recognized that the electrical length L of each of the S and S in the first set P1 is longer by dh than the electrical length L′ of each of the S and S in the second set P2.

For this reason, the transmission time from the start to the goal of signals to be transmitted in each of the S and S of the first set P1 and that from the start to the goal of signals to be transmitted in each of the S and S of the second set P2 are different, thereby causing skew (displacement between signals) between the adjacent sets.

The problem of the skew occurring between the adjacent sets is caused by the fact that the S and S in the first set P1 to be two base vertexes in the base of the isosceles triangle are located on the back side, whereas the S and S in the second set P2 to be two base vertexes in the base of the isosceles triangle are located on the front side, in the board connecting portion 122 of the contact 120. The problem of skew between the adjacent sets also occurs between the second set P2 and the third set P3, and between the third set P3 and the fourth set P4, in the similar manner.

### SUMMARY

Accordingly, the present invention has been made in view of the above circumstances, and an object of the present invention is to provide a board mounted connector in which an occurrence of skew between adjacent sets can be prevented.

In order to achieve the above object, inter alia, there is provided a board mounted connector is provided in which a skew occurrence can be prevented between adjacent sets of contacts.

The board mounted connector includes a housing and a plurality of contacts provided in the housing that are connected to a printed circuit board. Each of the plurality of contacts includes a contact portion, a securing portion, and a board connecting portion that connect to the printed circuit board. The plurality of contacts include a first signal contact and a second signal contact positioned next to the first signal contact such that the first signal contact and the second signal contact form a first set of signal contacts positioned along the printed circuit board. The first signal contact is arranged on an inner side of the printed circuit board while the second signal contact is arranged on an outer side of the printed circuit board.

### BRIEF DESCRIPTION OF THE DRAWINGS

The objects, features and advantages of the invention will become more apparent by describing in detail embodiments thereof with reference to the accompanying drawings, in which:

FIG. 1A is a side sectional view of a board mounted connector according to an embodiment of the invention;

FIG. 1B is a schematic illustration of multiple contacts of the board mounted connector shown in FIG. 1A;

FIG. 2 is a schematic view of the board mounted connector shown in FIG. 1A and FIG. 1B, to illustrate the arrangement of the multiple contacts when viewed from the front;

FIG. 3 is a plan view of a circuit pattern on a printed circuit board on which the board mounted connector shown in FIG. 1A and FIG. 1B is mounted;

FIG. 4A is a side sectional view of a board mounted connector according to another embodiment of the invention;

FIG. 4B is a schematic illustration of multiple contacts of the board mounted connector shown in FIG. 4A;

FIG. 5 is a schematic view of the board mounted connector shown in FIGS. 4A and FIG. 4B, to illustrate the arrangement of the multiple contacts when viewed from the front;

FIG. 6 is a plan view of a circuit pattern on a printed circuit board on which the board mounted connector shown in FIG. 4A and FIG. 4B is mounted;

FIG. 7A is a top view of a conventional connector for transmitting the high-speed differential signals;

FIG. 7B is a front view of the conventional connector for transmitting the high-speed differential signals; and

FIG. 8 is a sectional side view of the conventional connector shown in FIGS. 7A and 7B.

### DETAILED DESCRIPTION OF THE EMBODIMENT(S)

Hereinafter, embodiments of the present invention will be described with reference to the drawings.

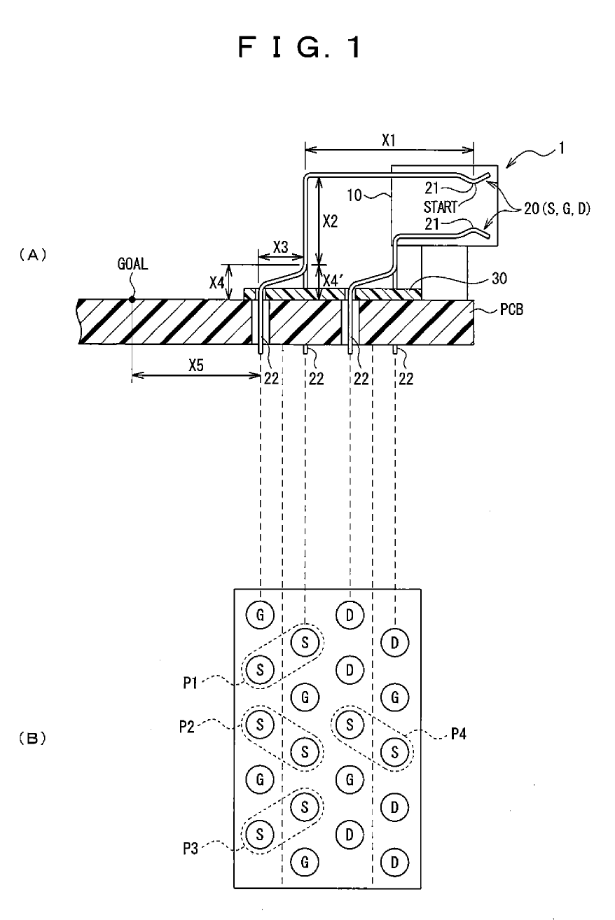

A board mounted connector 1 according to an embodiment of the invention will be described with reference to FIG. 1A, FIG. 1B to FIG. 3.

The board mounted connector 1 shown in FIG. 1A and FIG. 1B functions as a connector for transmitting high-speed differential signals in a balanced transmission system (differential signaling system).

The board mounted connector 1 includes a housing 10, a plurality of contacts 20, and a tine plate 30 for aligning board connecting portions 22 of the plurality of contacts 20.

In the shown embodiment, the housing 10 is made from a molded insulating resin and adapted to receive a mating plug connector (not illustrated).

In the shown embodiment, the plurality of contacts 20 includes a plurality of signal contact S (hereinafter, simply referred to as “S”), a plurality of ground contacts G (hereinafter, simply referred to as “G”), and plurality of low speed transmission contacts D (hereinafter, simply referred to as “D”), which are arranged in upper and lower rows of the housing 10. D is a general contact for power supply or the like.

Each of the plurality of contacts 20 is provided with a contact portion 21 for contact with a mating contact (not illustrated) and a board connecting portion 22 for connection with a printed circuit board PCB, as shown in FIG. 1A. Each of the plurality of contacts 20 is made by stamping and forming a metal plate. Each of the plurality of contacts 20 is secured to the housing 10 at a securing part horizontal to the housing 10. The contact portion 21 extends substantially frontward from the securing part (as shown in FIG. 1A). The board connecting portion 22 extends backward from the securing part, then bends downward at right angle (in the embodiment shown), and extends to penetrate through the printed circuit board PCB. However, as shown in FIG. 1A and FIG. 1B, the board connecting portion 22 of the plurality of contacts 20 in the upper row and the board connecting portion 22 of the plurality of contacts 20 in the lower row are arranged in a staggered configuration along the printed circuit board PCB in the contact row direction. That is to say, some of the board connecting portions 22 of the plurality of contacts 20 in the upper row and some of the board connecting portions 22 of the plurality of contacts 20 in the lower row bend downward at right angle and extend to penetrate through the printed circuit board PCB directly, and the others thereof bend downward at right angle, then bend backward (to the left in FIG. 1A and FIG. 1B) once, and bend downward again to penetrate through the printed circuit board PCB.

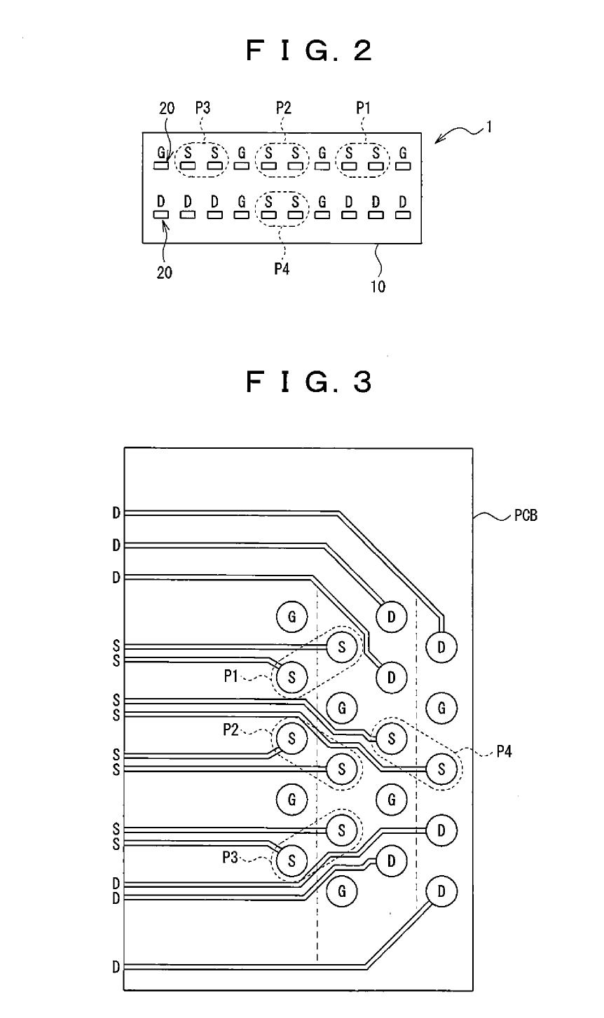

Herein, the plurality of contacts 20 are arranged along a mating portion, as shown in FIG. 2, in the order of G, S, S, G, S, S, G, S, S, and G from the right side in the upper row. In addition, plurality of contacts 20 are arranged along the mating portion, in the order of D, D, D, G, S, S, G, D, D, and D from the right side in the lower row.

In the upper row of the mating portion, as shown in FIG. 2, the first G from the right side and adjacent S and S are arranged in this order in a row direction. The two S of them constitute a first set P1. Then, the two S constituting the first set P1 and the ground contact G adjacent on the right side of the first set P1 are arranged in the order of the ground contact G and a pair of S in the row direction to extend in the same plane from a contact portion 21 to the board connecting portion 22.

As shown in FIG. 1B, the two S that constitute the first set P1 in the board connecting portion 22 of the plurality of contacts 20. One of the two S constituting the first set P1 is located on the outer side (see FIG. 1B) of the printed circuit board PCB, and the other thereof is located on the inner side of the printed circuit board PCB. Specifically, the S located on the outer side of the printed circuit board PCB is a + signal contact, whereas the S located on the inner side of the printed circuit board PCB is a − signal contact having the opposite polarity. The + signal contact and the − signal contact may be located reversely. The S located on the outer side of the printed circuit board PCB is a signal contact in which the board connecting portion 22 penetrates through the printed circuit board PCB directly. Additionally, the S located on the inner side of the printed circuit board PCB and the ground contact G are contacts in which the board connecting portions 22 bend backward (left side in FIG. 1A, which is same as the inner side of the printed circuit board PCB) once, and bend downward again to penetrate through the printed circuit board PCB.

Furthermore, in the upper row of the mating portion, the fourth G from the right side and two S adjacent thereto are arranged in the row direction in this order. The two S constitute a second set P2. The two S constituting the second set P2 and the G adjacent on the right side to the second set P2 are arranged in the order of one the G and a pair of S in the row direction to extend in the same plane from the contact portion 21 to the board connecting portion 22.

In the board connecting portion 22, as shown in FIG. 1B, two S constitute the second set P2. One of two the S that constituting the second set P2 is located on the outer side of the printed circuit board PCB, and the other thereof is located on the inner side of the printed circuit board PCB. Specifically, the S located on the outer side of the printed circuit board PCB is a − signal contact, whereas the S located on the inner side of the printed circuit board PCB is a + signal contact having the opposite polarity. The + signal contact and the − signal contact may be located reversely. The S located on the outer side of the printed circuit board PCB is a signal contact in which the board connecting portion 22 penetrates through the printed circuit board PCB directly. Additionally, the S located on the inner side of the printed circuit board PCB and the G are contacts in which the board connecting portions 22 bend backward once, and bend downward again to penetrate through the printed circuit board PCB.

Furthermore, in the upper row of the mating portion, the seventh G from the right side and two S adjacent thereto are arranged in the row direction in this order. The two S constitute a third set P3. The two S constituting the third set P3 and the G adjacent on the right side of the third set P3 are arranged in the order of the G and a pair S in the row direction to extend in the same plane from the contact portion 21 to the board connecting portion 22.

Then, in the board connecting portion 22 of the plurality of contacts 20, as shown in FIG. 1B, two S constitute the third set P3. One of the two S constituting the third set P3 is located on the outer side of the printed circuit board PCB, and the other thereof is located on the inner side of the printed circuit board PCB. Specifically, the S located on the outer side of the printed circuit board PCB is a + signal contact, whereas the S located on the inner side of the printed circuit board PCB is a − signal contact having the opposite polarity. The + signal contact and the − signal contact may be located reversely. The S located on the outer side of the printed circuit board PCB is a signal contact in which the board connecting portion 22 penetrates through the printed circuit board PCB directly. Additionally, the S located on the inner side of the printed circuit board PCB and the G are contacts in which the board connecting portions 22 bend backward once, and bend downward again to penetrate through the printed circuit board PCB.

The tenth G from the right side in the upper row of the mating portion extends to reach the board connecting portion 22 from the contact portion 21, and the board connecting portion 22 bends downward and directly extends to penetrate through the printed circuit board PCB.

On the other hand, in the lower row of the mating portion, the three D, D, and D that are the first to third contacts of the plurality of contacts 20 from the right side and three D, D, and D that are the eighth to tenth contacts of the plurality of contacts 20 from the right side extend to the board connecting portion 22 from the contact portion 21 for contact with the mating contact, and are arranged in a staggered configuration in the board connecting portion 22.

Furthermore, in the lower row of the mating portion, the fourth G from the right side and two S adjacent thereto are arranged in the row direction in this order, and the two S constitute a fourth set P4. The two S constituting the fourth set P4 and the G, adjacent on the right side thereof, are arranged in the order of the G and a pair S in the row direction to extend in the same plane from the contact portion 21 to the board connecting portion 22.

Then, in the board connecting portion 22, as shown in FIG. 1B, the two S constitute the fourth set P4. One of the S constituting the fourth set P4 is located on the outer side of the printed circuit board PCB, and the other thereof is located on the inner side of the printed circuit board PCB. Specifically, the S located on the outer side of the printed circuit board PCB is a − signal contact, whereas the S located on the inner side of the printed circuit board PCB is a + signal contact having the opposite polarity. The + signal contact and the − signal contact may be located reversely. The S located on the outer side of the printed circuit board PCB is a signal contact in which the board connecting portion 22 penetrates through the printed circuit board PCB directly. Additionally, the S located on the inner side of the printed circuit board PCB and the G are contacts in which the board connecting portions 22 bend backward once, and bend downward again to penetrate through the printed circuit board PCB.

Furthermore, the seventh the G from the right side in the lower row of the mating portion extends to reach the board connecting portion 22 from the contact portion 21 for contact with the mating contact. The board connecting portion 22 bends downward at right angle, then bends backward once, and bends downward again to penetrate through the printed circuit board PCB.

The board mounted connector 1 with the above configuration is mounted on the printed circuit board PCB having a circuit pattern as shown in FIG. 3.

In the embodiment shown in FIG. 1B and FIG. 3, a pair of S constitutes one set in the board connecting portion 22, with each of the sets labeled P1, P2, P3, and P4, as described above.

Subsequently, adjacent sets, specifically, the first set P1 and the second set P2 in the shown board mounted connector 1 will be discussed.

In this case, in the board connecting portion 22, as shown in FIG. 1B and FIG. 3, one of the S constituting the first set P1 is located on the outer side of the printed circuit board PCB, and the other thereof is located on the inner side of the printed circuit board PCB. On the other hand, one of the S constituting the second set P2, adjacent to the first set P1, is located on the outer side of the printed circuit board PCB, and the other thereof is located on the inner side of the printed circuit board PCB. Herein, one of the S in the first set P1 and one S in the second set P2 are located on the outer side of the printed circuit board PCB, and the electrical lengths thereof are equal. In addition, the other S in the first set P1 and the other S in the second set P2 are located on the inner side of the printed circuit board PCB, and the electrical lengths thereof are equal. Hence, there is no difference between the electrical lengths of the S in the adjacent sets P1 and P2. Therefore, since there is no difference between the transmission times for transmitting the signals in S of the adjacent sets P1 and P2, no skew occurs.

In addition, the same fact applies to the adjacent sets P2 and P3, and there is no difference between the electrical lengths of the S. Therefore, since there is no difference between the transmission times for transmitting the signals in the S of the adjacent sets P2 and P3, no skew occurs.

Moreover, the two S constituting the first set P1 are arranged in the same plane in the row direction from the contact portion 21 to the board connecting portion 22. For this reason, the electrical lengths of the two S (X1+X2 in FIG. 1A) are equal in the part ranging from the contact portion 21 to the board connecting portion 22. Therefore, since there is no difference between the transmission times for transmitting the signals in the S of the adjacent sets P1 and P2, no skew occurs. Additionally, the electrical lengths of the signal contacts S and the G are equal in the part ranging from the contact portion 21 to the board connecting portion 22.

The same fact applies to the two signal contacts S constituting the second, third, and fourth sets P2, P3, and P4. The electrical lengths of the two S in each set are equal in the part ranging from the contact portion 21 to the board connecting portion 22. Furthermore, the electrical lengths of the signal S and the G are equal in the part ranging from the contact portion 21 to the board connecting portion 22.

Referring to FIG. 1A and FIG. 1B, the electrical lengths of one S of the first set P1, one S of the second set P2, and one S of the third set P3, located in the board connecting portion 22 on the inner side of the printed circuit board will be described.

In each of the sets P1, P2, and P3, in the board connecting portion 22, the electrical length X of the S located in the board connecting portion 22 on the inner side of the printed circuit board PCB is a length from the start of the contact portion 21 in each of the S to the goal of a predefined point on the printed circuit board PCB. These electrical lengths X, in FIG. 1A, can be represented by the following expression.

The electrical length X≈X1+X2+X3+X4+X5 (4),

where X1 denotes a length from the contact portion 21 (start) of the S in the upper row to a first downward bend (i.e. right angle bend in the contact portion), X2 denotes a length from the first bend to the board connecting portion 22, X3 denotes a length from the point bending backward to a second downward bend (located in the board connecting portion 22), X4 denotes a length from the point where the S bends downward (the second downward bend) again to the printed circuit board PCB, and X5 denotes a length from the board connecting portion 22 to the goal.

These electrical lengths X are common in all the signal contacts the S located on the inner side of the printed circuit board PCB in each of the sets P1, P2, and P3, in the board connecting portion 22. Therefore, since there is no difference between the transmission times for transmitting the signals in the signal contacts the S in each of the sets P1, P2, and P3, no skew occurs.

Moreover, in each of the sets P1, P2, and P3, in the board connecting portion 22, considerations will be given of the electrical lengths of the other S of the first set P1, the other S of the second set P2, and the other S of the third set P3, located on the outer side of the printed circuit board.

In each of the sets P1, P2, and P3, in the board connecting portion 22, the electrical length X′ of the S located on the outer side of the printed circuit board PCB is a length from the start of the contact portion 21 in each of the signal contacts the S to the goal of a predefined point on the printed circuit board PCB. These electrical lengths X′, in FIG. 1A, can be represented by the following expression.

The electrical length X′=X1+X2+X4′+X3+X5 (5)

where X1 denotes a length from the contact portion 21 (start) of the S in the upper row to a first downward bend (i.e. right angle bend in the contact portion), X2 denotes a length from the first bend to the board connecting portion 22, X3 denotes a length from the point bending backward to a second downward bend (located in the board connecting portion 22), and X4′ denotes a length to reach the goal in the board connecting portion 22 of the S in the upper row.

These electrical lengths X′ are common in all the signal contacts the S located on the outer side of the printed circuit board PCB in each of the sets P1, P2, and P3, in the board connecting portion 22. Therefore, since there is no difference between the transmission times for transmitting the signals in the signal contacts the S in each of the sets P1, P2, and P3, no skew occurs.

Moreover, in each of the sets P1, P2, and P3, in the board connecting portion 22, the electrical length X of the S located on the inner side of the printed circuit board PCB is compared with the electrical length X′ of the S located on the outer side of the printed circuit board PCB.

X4 in the expression (4) representing the electrical length X and X4′ in the expression (5) representing the electrical length X′ are equal with reference to FIG. 1A.

Accordingly, the expression (5) can be changed to the following expression.

The electrical length X′=X1+X2+X3+X4+X5 (6)

When the expression (4) and the expression (6) are compared, it is understood that the electrical length X and the electrical length X′ are substantially equal.

Accordingly, in each of the sets P1, P2, and P3, in the board connecting portion 22, the electrical length X of the S located on the inner side of the printed circuit board PCB and the electrical length X′ of the S located on the outer side of the printed circuit board PCB are substantially equal. Therefore, since the transmission times for transmitting the signals in the signal contacts the S and S are almost same, no skew occurs between the signal contacts the S and S in each of the sets P1, P2, and P3.

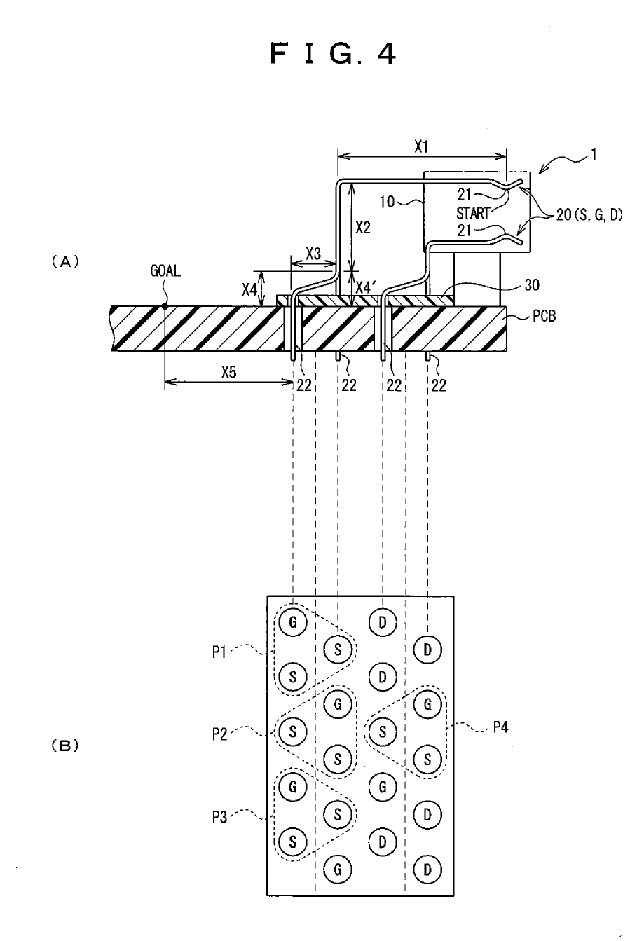

Now with reference to FIG. 4A, FIG. 4B to FIG. 6, another board mounted connector according to the invention will be described. Specifically, in FIG. 4A, FIG. 4B to FIG. 6, the same members as those employed in the first embodiment shown in FIG. 1A, FIG. 1B to FIG. 3 have the same reference numerals and detailed explanations thereof will be omitted, unless otherwise specified.

The board mounted connector 1 shown in FIG. 4A, FIG. 4B to FIG. 6 functions as a connector for transmitting high-speed differential signals to be used in the balanced transmission system (differential signaling system) in the same manner as the board mounted connector 1 shown in FIG. 1A, FIG. 1B to FIG. 3.

The board mounted connector 1 shown in FIG. 4A, FIG. 4B to FIG. 6 is different from the board mounted connector 1 shown in FIG. 1A, FIG. 1B to FIG. 3 with respect to the following points.

That is to say, they are different in that two S constitute one set in the board connecting portion 22 of the board mounted connector 1 shown in FIG. 1A to FIG. 3, whereas one G and two S constitute a set of a triangle in the board mounted connector 1 shown in FIG. 4A, FIG. 4B to FIG. 6.

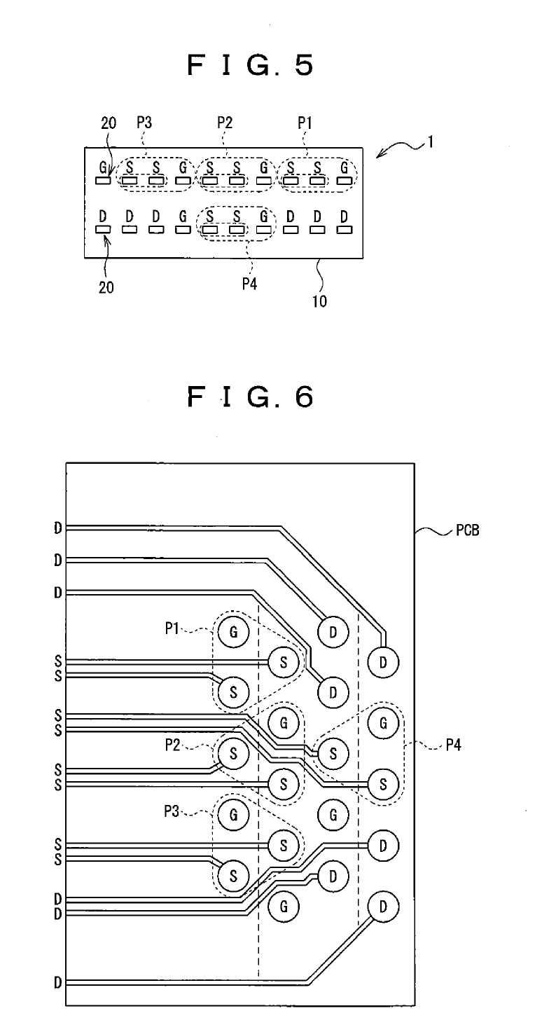

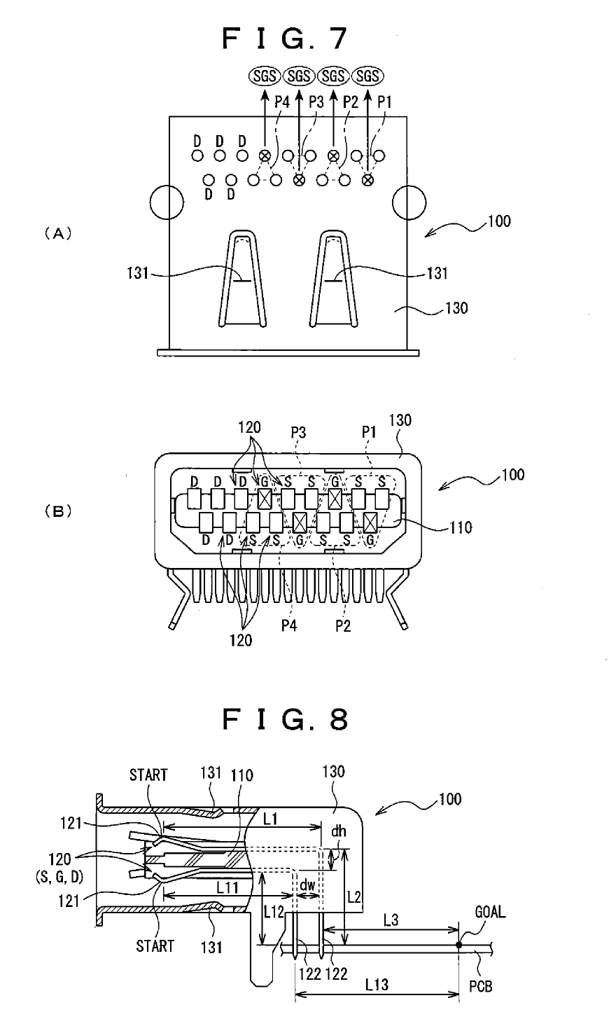

The difference will now be described in detail. In the board mounted connector 1 according to the embodiment shown in FIG. 5, in the upper row of the mating portion, the first the G on the rightmost side and two adjacent S thereto constitute a first set P1 and are arranged in this order in the row direction. Then, one G and two S constituting the first set P1 are arranged in the order of one G and a pair of S such they extend in the same plane in the part from the contact portion 21 to the board connecting portion.

Then, in the board connecting portion 22 of the plurality of contacts 20, as shown in FIG. 4B, one G and two S constitute the first set P1 of an equilateral triangle. One top vertex of the equilateral triangle constituting the first set P1 is located on an outer side of the printed circuit board PCB (shown as right side in FIG. 4B). Then, one of the two S (that is the signal contact in which the board connecting portion 22 penetrates through the printed circuit board PCB directly) is located at this top vertex of the equilateral triangle. On the other hand, two base vertexes in the base of the equilateral triangle are located on the inner side of the printed circuit board PCB. The other S (that is the signal contact in which the board connecting portion 22 bends backward once and bends downward again to penetrate through the printed circuit board PCB) and the G (that is the ground contact in which the board connecting portion 22 bends backward once and bends downward again to penetrate through the printed circuit board PCB) are located at the two base vertexes in the base of the equilateral triangle. The S located at the top vertex of the equilateral triangle is a + signal contact, and the S located at the base of the equilateral triangle is a − signal contact having the opposite polarity. The + signal contact and the − signal contact may be located reversely.

In addition, in the upper row of the mating portion, as shown in FIG. 5, the fourth G from the right side and two adjacent S thereto constitute a second set P2 and are located in this order in the row direction. The G and two S constituting the second set P2 are positioned the order of the G and the pair of S along the row direction, such that they extend in the same plane in a part ranging from a contact portion 21 to the board connecting portion 22. Subsequently, as shown in FIG. 4B, the G and two S constitute the second set P2 of an equilateral triangle in the board connecting portion 22 of the plurality of contacts 20. One top vertex of the equilateral triangle constituting the second set P2 of the equilateral triangle is located on the inner side of the printed circuit board PCB that extends in the inner-outer direction. Of the two S that constitute the second set P2, one S (that is the signal contact in which the board connecting portion 22 bends backward once and bends downward again to penetrate through the printed circuit board PCB) is located at the top vertex of the equilateral triangle. Two base vertexes in the base of the equilateral triangle are located on the outer side of the printed circuit board PCB. The other S (that is the signal contact in which the board connecting portion 22 penetrates through the printed circuit board PCB directly) and the G (that is the ground contact in which the board connecting portion 22 penetrates through the printed circuit board PCB directly) are located at the two base vertexes in the base of the equilateral triangle. The S located at the top vertex of the equilateral triangle is a + signal contact, and the S located at the base vertex of the equilateral triangle is a − signal contact having the opposite polarity. The + signal contact and the − signal contact may be arranged reversely.

Furthermore, in the upper row of the mating portion, as shown in FIG. 5, the seventh the G from the right side and two S adjacent thereto constitute a third set P3 and are arranged in this order in the row direction. The G and two S constituting the third set P3 are located in the order of the G and the pair of S along the row direction, such that they extend in the same plane in a part ranging from the contact portion 21 to the board connecting portion 22. Subsequently, as shown in FIG. 4B, the G and two S constitute the third set P3 of an equilateral triangle in the board connecting portion 22 of the plurality of contacts 20. One top vertex of the equilateral triangle that constitutes the third set P3 of the equilateral triangle is located on the outer side (on the right side in FIG. 4B) of the printed circuit board PCB that extends in the inner-outer direction. One of the S (that is the signal contact in which the board connecting portion 22 penetrates through the printed circuit board PCB directly) is located at the top vertex of the equilateral triangle. On the other hand, two base vertexes in the base of the equilateral triangle are located on the inner side of the printed circuit board PCB. The other S (that is the signal contact in which the board connecting portion 22 bends backward once and bends downward again to penetrate through the printed circuit board PCB) and the G (that is the ground contact in which the board connecting portion 22 bends backward once and bends downward again to penetrate through the printed circuit board PCB) are located at the two base vertexes in the base of the equilateral triangle. The S located at the top vertex of the equilateral triangle is a + signal contact, and the S located at the base vertex of the equilateral triangle is a − signal contact having the opposite polarity. The + signal contact and the − signal contact may be arranged reversely.

The tenth G from the right side in the upper row of the mating portion extends to reach the board connecting portion 22 from the contact portion 21, and the board connecting portion 22 bends downward and directly extends to penetrate through the printed circuit board PCB.

On the other hand, in the lower row of the mating portion, three D, D, and D that are the first to third contacts of the plurality of contacts 20 from the right side and three D, D, and D that are the eighth to tenth contacts of the plurality of contacts 20 from the right side extend to the board connecting portion 22 from the contact portion 21 for contact with the mating contact, and are arranged in a staggered configuration in the board connecting portion 22.

Moreover, in the lower row of the mating portion, as shown in FIG. 5, the fourth G from the right side and two S adjacent thereto constitute a fourth set P4 and are arranged in this order in the row direction. The G and two S constituting the fourth set P4 are arranged in the order of one the G and the pair of S along the row direction, such that they extend in the same plane in a part ranging from the contact portion 21 to the board connecting portion 22. Subsequently, as shown in FIG. 4B, the G and two S constitute the fourth set P4 of an equilateral triangle in the board connecting portion 22 of the plurality of contacts 20. One top vertex of the equilateral triangle that constitutes the fourth set P4 of the equilateral triangle is located on the inner side (left side in FIG. 4B) of the printed circuit board PCB that extends in the inner-outer direction. One S (that is the signal contact in which the board connecting portion 22 bends backward once and bends downward again to penetrate through the printed circuit board PCB) is located at the top vertex of the equilateral triangle. On the other hand, two base vertexes in the base of the equilateral triangle are located on the outer side of the printed circuit board PCB. The other S (that is the signal contact in which the board connecting portion 22 penetrates through the printed circuit board PCB directly) and the G (that is the ground contact in which the board connecting portion 22 penetrates through the printed circuit board PCB directly) are located at the two base vertexes in the base of the equilateral triangle. The S located at the top vertex of the equilateral triangle is a + signal contact, and the S located at the base of the equilateral triangle is a − signal contact having the opposite polarity.

The + signal contact and the − signal contact may be arranged reversely.

Furthermore, the seventh the G from the right side in the lower row of the mating portion extends from the contact portion 21 to the board connecting portion 22. The board connecting portion 22 bends downward at right angle, then bends backward once, and bends downward again to penetrate through the printed circuit board PCB.

The board mounted connector 1 with such a configuration is mounted on the printed circuit board PCB having a circuit pattern shown in FIG. 6.

In the present embodiment, as shown in FIG. 4B and FIG. 6, in the board connecting portion 22 in each of the sets P1, P2, P3, and P4, one the G, one + the S, and one − the S constitute one set of an equilateral triangle. Then, one of the + the S and the − the S is located at the top vertex and the other thereof and the ground contact the G are located at the two base vertexes in the base of the equilateral triangle, so as to function as a connector for transmitting high-speed differential signals.

Subsequently, adjacent sets, specifically, the first set P1 and the second set P2 will be considered in the same manner as the board mounted connector 1 shown in FIG. 1A, FIG. 1B to FIG. 3. In this case, in the board connecting portion 22, as shown in FIG. 4B or FIG. 6, two S in the first set P1 are respectively located at the top vertex of the equilateral triangle (on the outer side of the printed circuit board PCB) and at the base vertex in the base thereof (on the inner side of the printed circuit board PCB). On the other hand, two S constituting the second set P2, adjacent to the first set P1, are respectively located at the top vertex of the equilateral triangle (on the inner side of the printed circuit board PCB) and at the base vertex in the base thereof (on the outer side of the printed circuit board PCB). Herein, as the S at the base vertexes in the base of the equilateral triangle in the first set P1 and the S at the top vertex of the equilateral triangle in the second set P2 are located on the inner side of the printed circuit board PCB, as shown in FIG. 4B and FIG. 6, the electrical lengths thereof are equal. In addition, the S at the top vertex of the equilateral triangle in the first set P1 and the S at the base vertex in the base of the equilateral triangle in the second set P2 are located on the outer side of the printed circuit board PCB, and the electrical lengths thereof are equal. Hence, there is no difference between the electrical lengths of the S in the adjacent sets P1 and P2. Therefore, since there is no difference between the transmission times for transmitting the signals in the signal contacts S, in the adjacent sets P1 and P2, no skew occurs.

Likewise, since the same fact applies to the adjacent sets P2 and P3, there is no difference between the electrical lengths of the S between the adjacent sets P2 and P3. Therefore, since there is no difference between the transmission times for transmitting the signals in the signal contacts S, in the adjacent sets P2 and P3, no skew occurs.

Furthermore, in the board mounted connector 1 in the present embodiment, one G and two S constituting the first set P1 are arranged in the order of G and a pair of S in the row direction, such that they extend in the same plane from the contact portion 21 to the board connecting portion 22. For this reason, the electrical lengths of the two signal contacts the S and S (X1+X2 in FIG. 4A) are same in the part ranging from the contact portion 21 to the board connecting portion 22. Therefore, since there is no difference between the transmission times for transmitting the signals in the two signal contacts the S and S, no skew occurs. Additionally, the electrical lengths of the signal contacts the S and S and the ground contact the G are equal in the part ranging from the contact portion 21 to the board connecting portion 22.

This fact applies to one G and two S constituting the second, third, and fourth sets P2, P3, and P4, respectively. The electrical lengths of the two S are equal in the part ranging from the contact portion 21 to the board connecting portion 22. In addition, the electrical lengths of these S and the G are equal in the part ranging from the contact portion 21 to the board connecting portion 22.

Herein, in each of the sets P1, P2, and P3, in the board connecting portion 22, considerations will be given to the electrical lengths of the S at the base vertex in the base of the equilateral triangle of the first set P1, the S at the top vertex of the equilateral triangle of the second set P2, and the S at the base vertex in the base of the equilateral triangle of the third set P3, which are located on the inner side of the printed circuit board PCB.

In each of the sets P1, P2, and P3, in the board connecting portion 22, the electrical length X of the S located on the inner side of the printed circuit board PCB is a length from a start of the contact portion 21 in each of the signal contacts the S to the goal of a predefined point on the printed circuit board PCB. These electrical lengths X, in FIG. 4A, can be represented by the following expression.

The electrical length X≈X1+X2+X3+X4+X5 (7),

where X1 denotes a length from the contact portion 21 (start) of the S in the upper row to a first bend (right angle bend in the contact portion 21), X2 denotes a length from the first bend of the S to the board connecting portion 22, X3 denotes a length from the point bending backward to a second downward bend (in the board connecting portion 22), X4 denotes a length from the point where the S bends downward again (second downward bend) to the point where the S reaches the printed circuit board PCB, and X5 denotes a length from the board connecting portion 22 to the goal.

These electrical lengths X are common in all the S arranged on the inner side of the printed circuit board PCB in each of the sets P1, P2, and P3, in the board connecting portion 22. Therefore, since there is no difference between the transmission times for transmitting the signals in the signal contacts the S in each of the sets P1, P2, and P3, no skew occurs.

Moreover, in each of the sets P1, P2, and P3, in the board connecting portion 22, considerations will be given to the electrical lengths of the S at the top vertex of the equilateral triangle of the first set P1, the S at the base vertex in the base of the equilateral triangle of the second set P2, and the S at the top vertex of the equilateral triangle of the third set P3, located on the outer side of the printed circuit board PCB.

In each of the sets P1, P2, and P3, in the board connecting portion 22, the electrical length X′ of the S located on the outer side of the printed circuit board PCB is a length from the start of the contact portion 21 in each of the signal contacts the S to the goal of a predefined point on the printed circuit board PCB. These electrical lengths X′, in FIG. 1A, can be represented by the following expression.

The electrical length X′=X1+X2+X4′+X3+X5 (8)

where X1 denotes a length from the contact portion 21 (start) of the S in the upper row to a first bend (right angle bend in the contact portion 21), X2 denotes a length from the first bend point of the S to the board connecting portion 22, X3 denotes a length from the point bending backward to a second downward bend (in the board connecting portion 22), and X4′ denotes a length to reach the printed circuit board PCB in the board connecting portion 22 of the S in the upper row.

These electrical lengths X′ are common in all the S located on the outer side of the printed circuit board PCB in each of the sets P1, P2, and P3, in the board connecting portion 22. Therefore, since there is no difference between the transmission times for transmitting the signals in the signal contacts S, in each of the sets P1, P2, and P3, no skew occurs.

Moreover, in each of the sets P1, P2, and P3, in the board connecting portion 22, the electrical length X of the S located on the inner side of the printed circuit board PCB is compared with the electrical length X′ of the S located on the outer side of the printed circuit board PCB.

X4 in the expression (7) representing the electrical length X and X4′ in the expression (8) representing the electrical length X′ are equal with reference to FIG. 4A.

Accordingly, the expression (8) can be changed to the following expression.

The electrical length X′=X1+X2+X3+X4+X5 (9)

When the expression (7) and the expression (9) are compared, it is understood that the electrical length X and the electrical length X′ are substantially equal.

Accordingly, in each of the sets P1, P2, and P3, in the board connecting portion 22, the electrical length X of the S located on the inner side of the printed circuit board PCB and the electrical length X′ of the S located on the outer side of the printed circuit board PCB are substantially equal. Therefore, since the transmission times for transmitting the signals in the signal contacts the S and S are almost same in each of the sets P1, P2, and P3, no skew occurs.

Moreover, in the present embodiment, one G and two S constitute one set of an equilateral triangle, in the board connecting portion 22. Thus, the distance between the G (ground contact) and one the S (+ signal contact) is equal to that between the G (ground contact) and the other S (− signal contact). Accordingly, since uniform impedance matching is attained between the G (ground contact) and one the S (+ signal contact), and the G (ground contact) and the other S (− signal contact), it is possible to maintain the high-speed transmission properties in the high-speed differential signal transmission.

Moreover, since one the S (+ signal contact) and the other S (− signal contact) are arranged to interpose the G (ground contact) there between, the impedance matching is achieved with ease.

Heretofore, the embodiments of the invention have been described. However, the invention is not limited to this, and various modifications and adaptations to those embodiments may occur.

For example, any board mounted connector may be employed such that in the board connecting portion 22, one G and two S constitute one set of not only an equilateral triangle but also a triangle having three sides of different lengths or an isosceles triangle. In the case where the isosceles triangle is used, the distance X3 between one signal contact and the ground contact and the distance X3 between one signal contact and the other signal contact are identical. Additionally, in the case where the equilateral triangle is employed, the distance from the ground contact to one signal contact and the distance from the ground contact to the other signal contact are identical, and there is no difference in the coupling of the ground contact in both signal contacts.

Moreover, the board connecting portion may be a surface mounted type, other than the printed circuit board penetrating type.

What is claimed is:

1. A board mounted connector comprising:
a housing; and
a plurality of contacts in the housing that are connected to a printed circuit board, each of the plurality of contacts having a contact portion, a securing portion, and a board connecting portion, the plurality of contacts include:
a first signal contact arranged on an inner side of the printed circuit board; and
a second signal contact arranged on an outer side of the printed circuit board and positioned next to the first signal contact such that the first signal contact and the second signal contact form a first set of signal contacts.

2. The board mounted connector according to claim 1, wherein the first set of signal contacts includes a positive signal contact and a negative signal contact.

3. The board mounted connector according to claim 1, wherein the first set of signal contacts is arranged in order along a row of the housing such that the first set of signal contacts extends in a common plane from the contact portion to the board connecting portion.

4. The board mounted connector according to claim 3, wherein the board connecting portion extends backward from the securing portion, then bends downward at a right angle, and extends through the printed circuit board.

5. The board mounted connector according to claim 4, wherein the second signal contact includes a second bend downward before passing through the printed circuit board.

6. A board mounted connector comprising:
a housing; and
a plurality of contacts in the housing that are connected to a printed circuit board, each of the plurality of contacts having a contact portion, a securing portion, and a board connecting portion, the plurality of contacts include:
a ground contact, a first signal contact, and a second signal contact that constitute a first set located in a triangle in the board connecting portion, the first set positioned such that the first signal contact is a top vertex of the triangle and is arranged on an inner or an outer side of the printed circuit board, and the second signal contact and the ground contact constitute two base vertexes on a base side of the triangle which are positioned opposite the top vertex of the triangle along the printed circuit board.

7. The board mounted connector according to claim 6, wherein the triangle is an isosceles triangle.

8. The board mounted connector according to claim 6, wherein the triangle is an equilateral triangle.

9. The board mounted connector according to claim 6, wherein the first signal contact is a positive signal contact and the second signal contact is a negative signal contact.

10. The board mounted connector according to claim 6, wherein the second signal contact is a positive signal contact and the first signal contact is a negative signal contact.

11. The board mounted connector according to claim 6, wherein the ground contact, the first signal contact, and the second signal contact are arranged in an order along a row in the housing such that the ground contact, the first signal contact, and the second signal contact extend in a common plane from the contact portion to the board connecting portion.

12. The board mounted connector according to claim 11, wherein the board connecting portion extends backward from the securing portion, then bends downward at a right angle, and extends through the printed circuit board.

13. The board mounted connector according to claim 12, wherein the first signal contact or the second signal contact arranged on an inner side of the printed circuit board includes a second downward bend located before the second signal contact passes through the printed circuit board.

14. The board mounted connector according to claim 6, further comprising a second ground contact, a third signal contact, and a fourth signal contact that constitute a second set of a second triangle in the board connecting portion, the second set positioned such that the third signal contact is a top vertex of the second triangle and is arranged on the inner or the outer side of the printed circuit board opposite the first signal contact, the fourth signal contact and the second ground contact constitute two base vertexes on a base side of the second triangle which are positioned opposite the third signal contact along the printed circuit board.
